(19) United States
(12) Patent Application Publication
(10) Pub. No.: US 2013/0284573 A1
(43) Pub. Date: Oct. 31, 2013

(54) KEYBOARD DEVICE

(71) Applicant: FUJITSU COMPONENT LIMITED, Tokyo (JP)

(72) Inventor: Takeshi NISHINO, Tokyo (JP)

(73) Assignee: Fujitsu Component Limited, Tokyo (JP)

(21) Appl. No.: 13/869,573

(22) Filed: Apr. 24, 2013

(30) Foreign Application Priority Data
Apr. 26, 2012 (JP) 2012-101878

(51) Int. Cl. H01H 13/10

(52) U.S. Cl. CPC H01H 13/10
USPC 200/293

(57) ABSTRACT

A keyboard device includes: a key top; a pair of link members coupled with the key top; and a support panel that is located below the key top, and includes first holes each housing a part of the link members.

### CROSS-REFERENCE TO RELATED APPLICATION

This application is based upon and claims the benefit of priority of the prior Japanese Patent Application No. 2012-101878 filed on Apr. 26, 2012, the entire contents of which are incorporated herein by reference.

### FIELD

A certain aspect of the embodiments is related to a keyboard device.

### BACKGROUND

A keyboard device is widely used as an input device of an electronic device such as a personal computer. For example, Japanese Laid-open Patent Publication No. 2000-173389 discloses a technique in which a pair of members having a gear mechanism are provided on a sheet. Japanese Laid-open Patent Publication No. 2001-155580 discloses a technique in which a key top moves up and down by rotationally moving a decussate member. Recently, a portable electronic device such as a note-type personal computer (i.e., a notebook PC) is widely used. For convenience of portability, weight saving and downsizing are required of the electronic device. In view of this, thinness is required of the keyboard device.

### SUMMARY

According to an aspect of the present invention, there is provided a keyboard device including: a key top; a pair of link members coupled with the key top; and a support panel that is located below the key top, and includes first holes each housing a part of the link members.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is an exploded perspective view illustrating a keyboard device according to a comparative example;

FIG. 1B is a cross-section view illustrating the keyboard device at the time of non-depression;

FIG. 2 is an exploded perspective view illustrating the keyboard device according to a first embodiment;

FIG. 3A is a cross-section view illustrating the keyboard device at the time of non-depression;

FIG. 3B is a perspective view seen from an arrow A of FIG. 3A;

FIG. 3C is a rear view seen from an arrow B of FIG. 3B;

FIG. 4A is a cross-section view illustrating the keyboard device at the time of depression;

FIG. 4B is a perspective view seen from an arrow A of FIG. 4A;

FIG. 4C is a rear view seen from an arrow B of FIG. 4B;

FIG. 5 is an exploded perspective view illustrating the keyboard device according to a second embodiment;

FIG. 6A is a cross-section view illustrating the keyboard device at the time of non-depression;

FIG. 6B is a perspective view seen from an arrow A of FIG. 6A;

FIG. 6C is a rear view seen from an arrow B of FIG. 6B;

FIG. 7A is a cross-section view illustrating the keyboard device at the time of depression;

FIG. 7B is a perspective view seen from an arrow A of FIG. 7A;

FIG. 7C is a rear view seen from an arrow B of FIG. 7B; and

FIG. 8 is a rear view illustrating an example in which the shape of a housing is changed.

### DESCRIPTION OF EMBODIMENTS

In the above-mentioned technique, the whole keyboard device may be thinned by making parts of the keyboard device thin. However, in this case, there is a possibility that the operation of the keyboard device is spoiled.

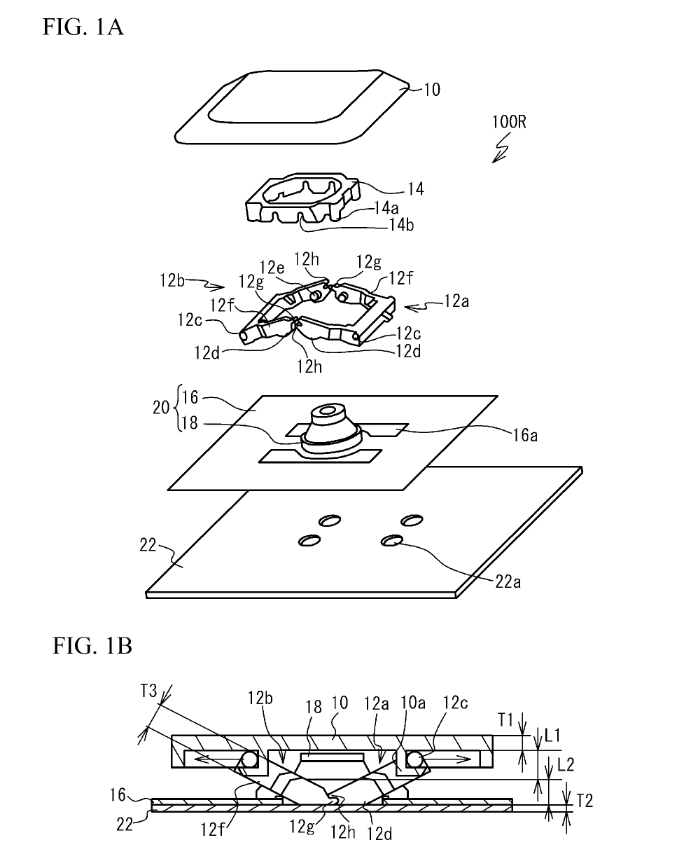

First, a description will be given of a comparative example. FIG. 1A is an exploded perspective view illustrating a keyboard device 100R according to the comparative example. FIG. 1B is a cross-section view illustrating the keyboard device 100R at the time of non-depression. In FIG. 1B, a part of a hook 10a is permeated, and projections 12c are illustrated.

As illustrated in FIGS. 1A and 1B, the keyboard device 100R a key top 10, two gear links 12a and 12b (link members), a housing 14, a membrane switch 20, and a support panel 22. The membrane switch 20 includes a membrane 16 and an operating member 18 provided on the membrane 16.

The support panel 22 is arranged below the key top 10, and the membrane switch 20 is arranged between the key top 10 and the support panel 22. An upper surface of the support panel 22 is opposed to the key top 10. Four holes 22a are provided on the support panel 22. The upper surface of the support panel 22 and the holes 22a are exposed from holes 16a provided on the membrane 16.

As illustrated in FIG. 1B, edge portions 12d of the gear links 12a and 12b by the side of the support panel 22 contact the upper surface of the support panel 22 exposed from the holes 16a. The housing 14 is arranged on the edge portions 12d, and base portions 14a of the housing 14 are housed into the holes 22a. The projections 12e are arranged under arch portions 14b of the housing 14, and are sandwiched between the housing 14 and the support panel 22. Thereby, the gear links 12a and 12b are fixed to the support panel 22.

A first tooth 12g is provided on one edge portion 12d (of a back side in FIG. 1A) of the gear link 12a, and a second tooth 12h is provided on another edge portion 12d (of a near side). The first tooth 12g and the second tooth 12h are provided on the gear link 12b. The first tooth 12g of the gear link 12a engages with the second tooth 12h of the gear link 12b, and the second tooth 12h of the gear link 12a engages with the first tooth 12g of the gear link 12b. Thus, a pair of the gear links 12a and 12b are coupled to each other via the edge portions 12d, and can operate simultaneously with each other.

Arm portions 12f extend towards the key top 10 from the edge portions 12d. The hooks 10a are projected from a lower surface of the key top 10. Projections 12c are provided on edge portions (by the side of the key top 10) opposed to the edge portions 12d. The projections 12c engage with the hooks 10a, so that the key top 10 is coupled to the gear links 12a and 12b. Surfaces facing the outside of the key top 10 of the hooks 10a are opened. In a distance from the key top 10 to the support panel 22, the length of the gear link 12a is the same as that of the gear link 12b, for example.

When the key top 10 is not depressed (non-depression time), the two gear links 12a and 12b are assembled like a shape of a V-character, and support the key top 10, as illustrated in FIG. 1B. For example, when the key top 10 is depressed (depression time) by a user's finger, the lower surface of the key top 10 depresses the operating member 18. Thereby, the membrane switch 20 is operated. When the finger is lifted from the key top 10, the key top 10 is pushed up by an upward elastic force of the operating member 18. The edge portions of the gear links 12a and 12b by the side of the key top 10 slide in a horizontal direction in response to the depression of the key top 10, as illustrated in arrows of FIG. 1B. The arm portions 12f fall downward. The gear links 12a and 12b guide the key top 10 in up-and-down directions while keeping the key top 10 horizontally.

The thickness of the keyboard device 100R is the sum of the thickness T1 of the key top 10, a stroke L1, a distance L2, and the thickness T2 of the support panel 22, for example. The stroke L1 is a distance in which the key top 10 is depressed. The distance L2 is a distance from the upper surface of the support panel 22 to the upper surface of the edge portions 12d . In order to make the operation of the keyboard device 100R favorable, it is required that the stroke L1 maintains a certain degree of size. For example, the edge portions 12d become thin by making the thickness T3 of the gear links 12a and 12b small. Thereby, the distance L2 can be made small. However, when the gear links 12a and 12b are too thin, it is difficult to secure the thickness of the first tooth 12g and the second tooth 12h. As a result, it is difficult to form the first tooth 12g and the second tooth 12h. Moreover, the rigidity of the gear links 12a and 12b reduces. Therefore, a function of the gear links 12a and 12b that support the key top 10 and operate simultaneously with each other is spoiled. Thereby, the operation of the keyboard device 100R is not performed smoothly.

### First Embodiment

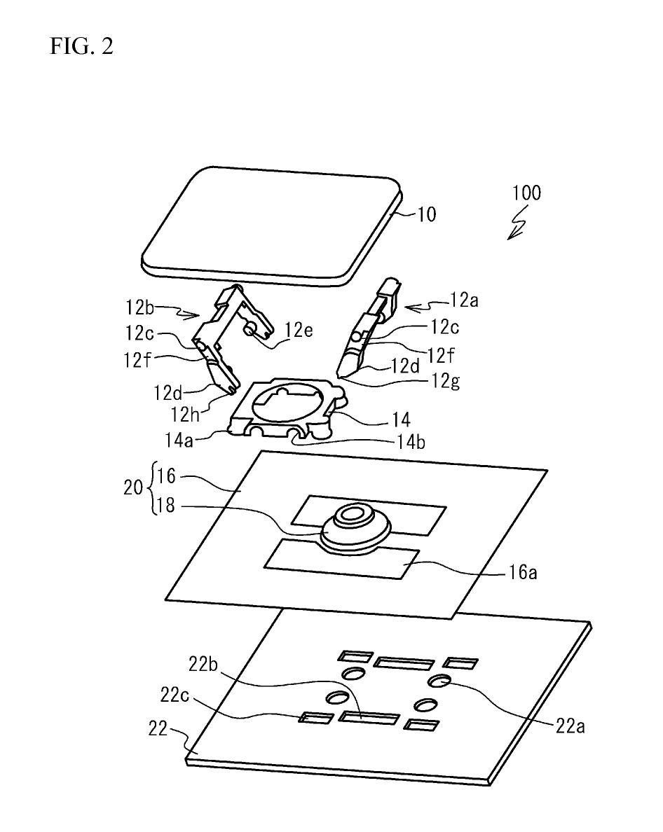

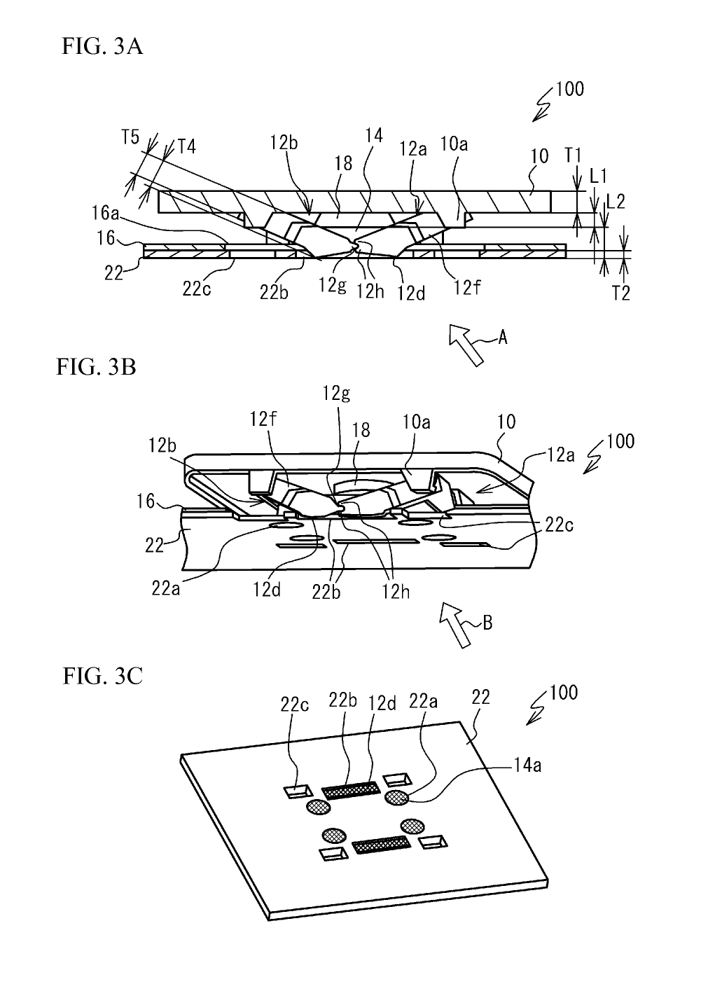

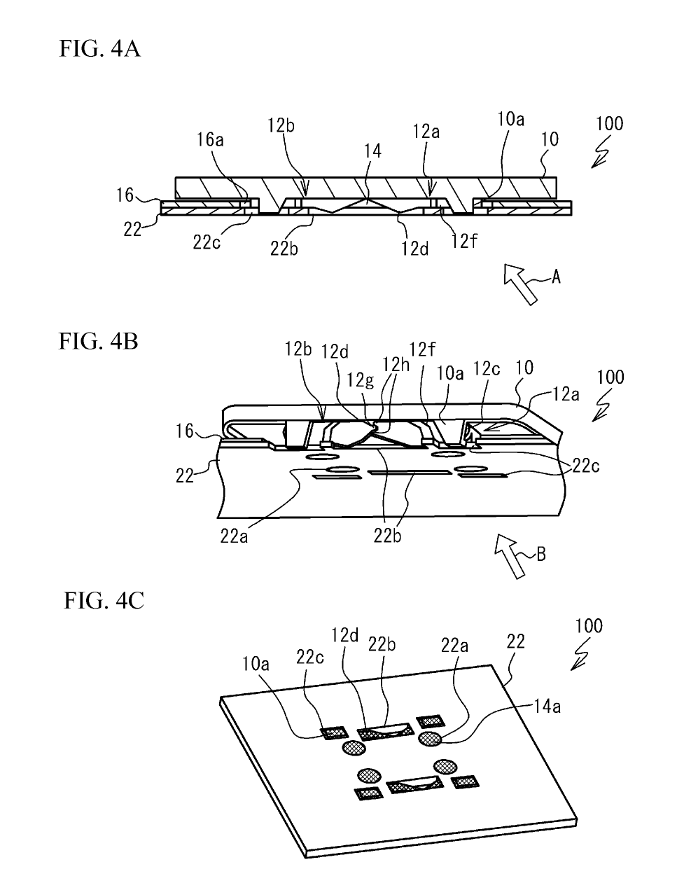

A first embodiment is an example of housing the edge portions 12d into the holes 22b of the support panel 22. FIG. 2 is an exploded perspective view illustrating a keyboard device 100 according to the first embodiment. FIG. 3A is a cross-section view illustrating the keyboard device 100 at the time of non-depression. FIG. 3B is a perspective view seen from an arrow A of FIG. 3A. FIG. 3C is a rear view seen from an arrow B of FIG. 3B. FIG. 4A is a cross-section view illustrating the keyboard device 100 at the time of depression. FIG. 4B is a perspective view seen from an arrow A of FIG. 4A. FIG. 4C is a rear view seen from an arrow B of FIG. 4B. In FIG. 3C, checked lattice lines are given to the gear links 12a and 12b and the base portion 14a. In FIG. 4C, checked lattice lines are also given to the hooks 10a in addition to the above-mentioned portions.

As illustrated in FIGS. 2A to 4C, four holes 22a, two holes 22b (i.e., first holes), and four holes 22c (i.e., second holes) are provided on the support panel 22. The holes 22a, 22b and 22c are exposed from the holes 16a of the membrane 16. The edge portions 12d (i.e., first portions) of the gear links 12a and 12b (i.e., link members) are housed into the holes 22b, respectively.

While the edge portions 12d are housed by the holes 22b at the time of depression, as illustrated in FIGS. 4A and 4B, the arm portions 12f (i.e., second portions) move downward, and contact the upper surface of the support panel 22, for example. As illustrated in FIG. 4C, the hooks 10a (i.e., coupling portions) are housed into the holes 22b.

According to the first embodiment, the edge portions 12d are housed into the holes 22b, so that the distance L2 becomes short by only the thickness T2 of the support panel 22. As a result, the keyboard device 100 can be made thin. Since it is not necessary to make the stroke L1 small, the operation of the keyboard device 100 is not prevented. That is, it is possible to achieve both of thinness and favorable operation.

As illustrated in FIG. 3A, the thickness T4 of each edge portion 12d is larger than the thickness T5 of each arm portion 12f. Therefore, the first tooth 12g and the second tooth 12h are can be formed on the edge portions 12d, respectively. The rigidity of the gear links 12a and 12b can be kept highly. The gear links 12a and 12b can support the key top 10 and operate simultaneously with each other. Therefore, the operation of the keyboard device 100 becomes favorable.

When the hooks 10a or the edge portions 12d are projected from the rear surface of the support panel 22 (i.e., a surface opposite to a surface which faces the key top 10), the projected hooks 10a or the projected edge portions 12d contact a housing (not shown) arranged under the support panel 22. Thereby, the range of movement of the gear links 12a and 12b becomes small. That is, the stroke L1 becomes short and the operation of the keyboard device 100 is prevented. Therefore, it is desirable that the hooks 10a or the edge portions 12d do not project from the rear surface of the support panel 22. Thereby, shortening of the stroke L1 is restrained. For example, at the time of depression, lowest points of the edge portions 12d and the lower surfaces of the hooks 10a may be located in the same height as the rear surface of the support panel 22. Thereby, it is possible to secure thinness and the stroke L1.

### Second Embodiment

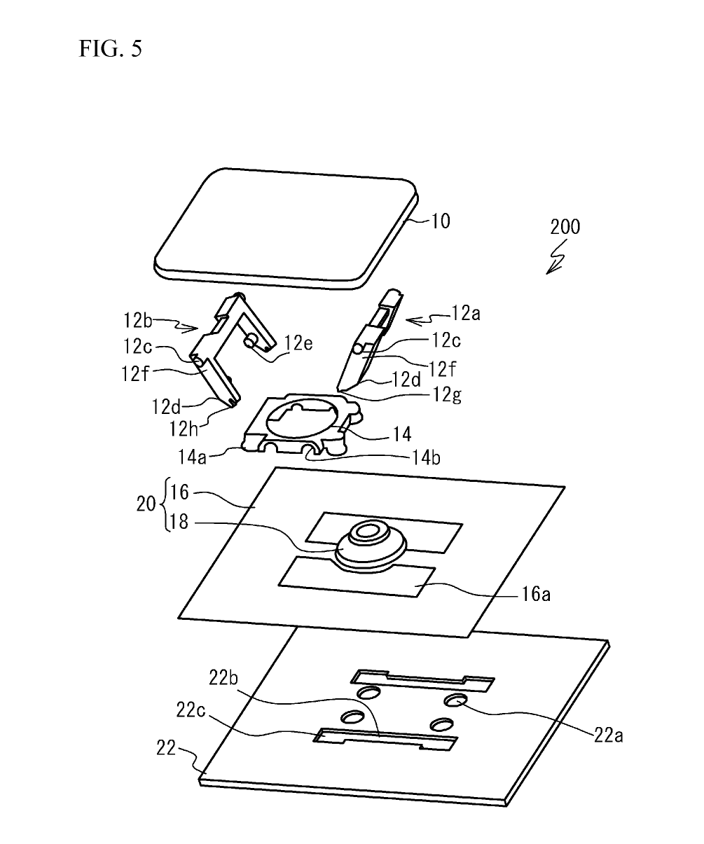

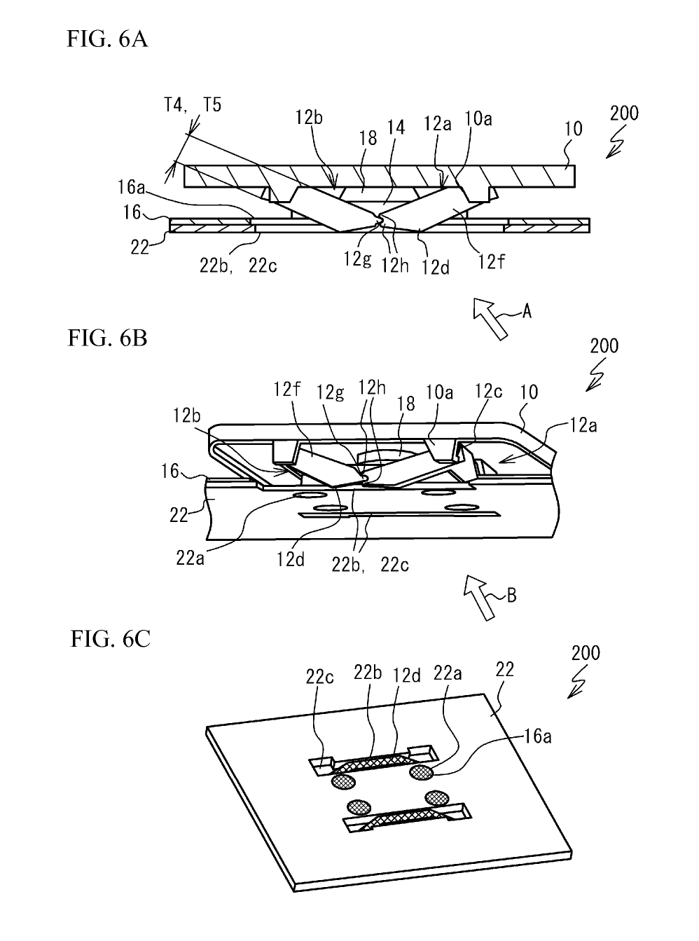

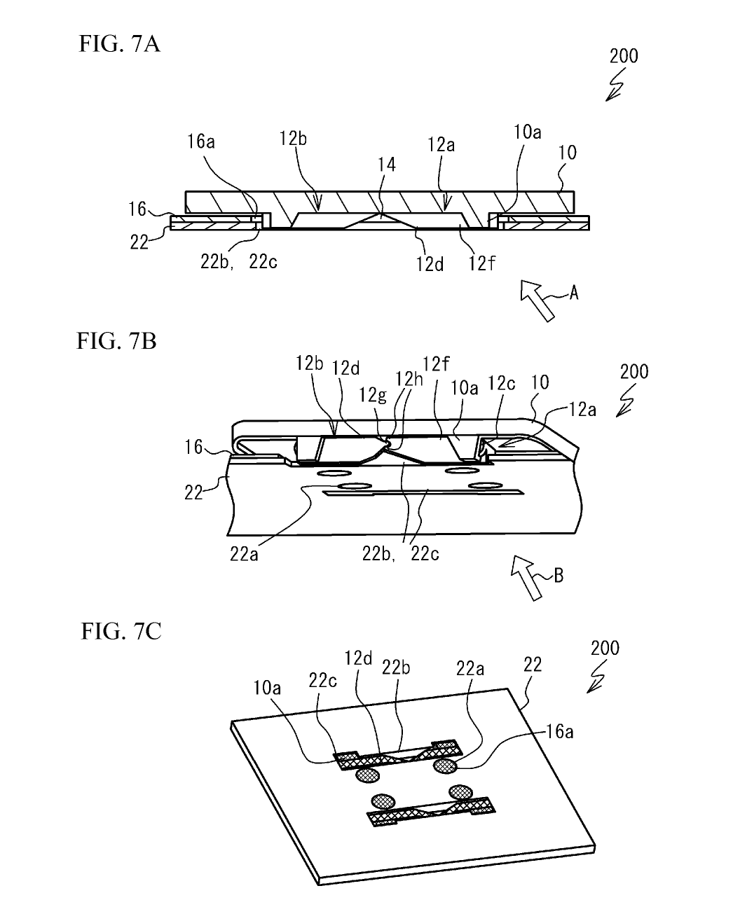

A second embodiment is an example in which the arm portions 12f are housed into the holes 22b. FIG. 5 is an exploded perspective view illustrating a keyboard device 200 according to a second embodiment. FIG. 6A is a cross-section view illustrating the keyboard device 200 at the time of non-depression. FIG. 6B is a perspective view seen from an arrow A of FIG. 6A. FIG. 6C is a rear view seen from an arrow B of FIG. 6B. FIG. 7A is a cross-section view illustrating the keyboard device 200 at the time of depression. FIG. 7B is a perspective view seen from an arrow A of FIG. 7A. FIG. 7C is a rear view seen from an arrow B of FIG. 7B.

The keyboard device 200 has the same structure as the keyboard device 100 except for the gear links 12a and 12b, and the support panel 22. As illustrated in FIG. 6A, the thickness T5 of the arm portions 12f are the same as the thickness T4 of the edge portions 12d. Therefore, the rigidity of the gear links 12a and 12b becomes higher, and the operation of the keyboard device 200 becomes favorable. The holes 22b of the second embodiment are larger than the holes 22b of the first embodiment, and are united with the holes 22c. As illustrated in FIGS. 7A to 7C, the holes 22b can house the edge portions 12d and the arm portions 12f, so that the keyboard device 200 can be thin. It is desirable that, at the time of depression, the edge portions 12d, the arm portions 12f and the lower surfaces of the hooks 10a are located in the same height as the rear surface of the support panel 22.

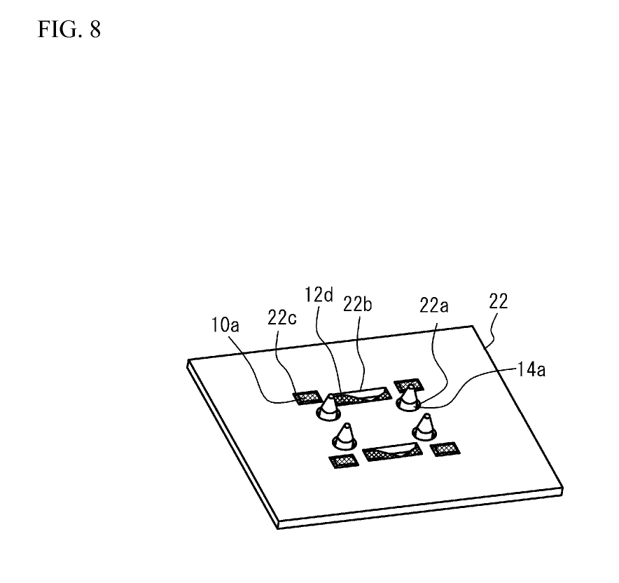

FIG. 8 is a rear view illustrating an example in which the shape of a housing 14 is changed. As illustrated in FIG. 8, the base portion 14a of the housing 14 may have shapes of pins that project from the rear surface of the support panel 22.

Also in the first and the second embodiments, each of the gear links 12a and 12b may have both of the first tooth 12g and the second tooth 12h, as with the comparative example. As illustrated in FIG. 3A, the gear links 12a and 12b are provided like the shape of the V-character so that the distance between the gear links from the side of the support panel 22 to the side of the key top 10 increases. However, the structure can be changed. For example, the gear links 12a and 12b may be provided like the shape of an inverted V-character so that the distance between the gear links from the side of the key top 10 to the side of the support panel 22 increases. Moreover, the edge portions 12d may be slid in the horizontal direction in the holes 22b in response to up-and-down operation of the key top 10. Although the edge portions 12d are housed into the holes 22b, the structure is limited to this. A part of the gear links 12a and 12b may be housed into the holes 22b, so that the keyboard device 200 can become thin. Instead of the gear links 12a and 12b, a pantograph-shaped link member may be used, for example.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A keyboard device comprising:
a key top;
a pair of link members coupled with the key top; and
a support panel that is located below the key top, and includes first holes each housing a part of the link members.

2. The keyboard device as claimed in claim 1, wherein each of the first holes houses first portions which respectively include edge portions of the link members by the side of the support panel.

3. The keyboard device as claimed in claim 2, wherein the edge portions of the link members are coupled with each other, and
the link members are coupled with the key top by another edge portions which are opposite to the edge portions.

4. The keyboard device as claimed in claim 2, wherein the link members includes second portions, respectively, which extend toward the key top from the first portions, and the thickness of each of the first portions is larger than that of each of the second portions.

5. The keyboard device as claimed in claim 2, wherein the link members includes second portions, respectively, which extend toward the key top from the first portions, and each of the first holes houses the first portions and the second portions when the key top is depressed.

6. The keyboard device as claimed in claim 5, wherein the thickness of each of the first portions is the same as that of each of the second portions.

7. The keyboard device as claimed in claim 1, wherein the key top includes coupling portions that are projected from a surface of the key top, the surface being opposite to the support panel, and are coupled with the link members,
second holes are provided on the support panel, and
the second holes house the coupling portions, respectively, when the key top is depressed.

8. The keyboard device as claimed in claim 1, wherein the part of the link members to be housed into each of the first holes is not projected from a surface of the support panel, the surface of the support panel being opposite to another surface thereof which faces the key top.

9. The keyboard device as claimed in claim 7, wherein the coupling portions are not projected from a surface of the support panel, the surface of the support panel being opposite to another surface thereof which faces the key top.
